(19) United States
(12) Patent Application Publication
(10) Pub. No.: US 2002/0163574 A1
(43) Pub. Date: Nov. 7, 2002

(54) Aperture controlled flicker reduction for active stereoscopic glasses

(76) Inventors: Adam W. Divelbiss, Wappingers Falls, NY (US); David C. Swift, Cortlandt Manor, NY (US)

Correspondence Address: RALPH J. CRISPINO, REVEO, INC., 85 EXECUTIVE BLVD., ELMSFORD, NY, 10523, US

(21) Appl. No.: 10/140,675

(22) Filed: May 7, 2002

Related U.S. Application Data
(60) Provisional application No. 60/289,096, filed on May 7, 2001.

(51) Int. Cl. H04N 13/04

(52) U.S. Cl. 348/56; 348/42

(57) ABSTRACT

Limiting or eliminating external light to the peripheral vision areas of the user reduces flicker. The aperture of the liquid crystal filter is dynamically adjusted to maintain a particular aspect ratio to match the image displayed by computers and television sets. The size of the aperture of the liquid crystal filter is user adjustable through a mechanical or electrical aperture system. The size of the aperture of the liquid crystal filter is automatically adjustable through an electrical aperture control system and a proximity system. The aperture is adjusted based on the sensed distance between the user and the display medium. The location of the aperture is automatically adjustable through an electrical aperture control system and head orientation system. The aperture location in front of the LC shutter is moved vertically or horizontally depending on the pointing direction of the users head with respect to the display system.

### BACKGROUND OF THE INVENTION

The invention relates stereoscopic viewing and in particlar to aperture controlled flicker reduction for active stereoscopic glasses.

One major shortcoming in the use of liquid crystal stereoscopic shutter systems for use on consumer computer systems involves the inherent flicker associated with low refresh rate computer images. Many average home computer users are not aware of the refresh rate controls on the monitor and they may use factory set low refresh rate values. Many stereoscopic shutter glass systems use liquid crystal shutters with fixed apertures that permit the user a fairly wide field of view. However, the wide field of view unnecessarily increases the flicker problem by permitting light from non-stereoscopic image sources (such as the monitor bezel and surrounding walls) to be seen by the peripheral vision areas of the eye. Since the peripheral vision is much better at detecting movement than the central visual areas, the perception of image flicker is actually increased.

Because of the shortcomings of current state-of-the art shutter glass systems, there is a need for a new system that limits the field of view of the user while still enabling the user to see the full and complete 3D image. Further there is a need to allow the user to manually adjust the field of view based on the viewing distance. Further, for greater simplicity of use, there is a need for automatic adjustment of the field of view of the user. The object of this invention address each of these needs and provides a system that reduces perceived flicker in 3D stereoscopic images by limiting the light sensed by the peripheral vision of the user. Previous patents and patent applications by Reveo (Lazzaro), Guralnick, Stereographics and Tetratel have fixed field of view LC filters.

### SUMMARY OF THE INVENTION

Limiting or eliminating external light to the peripheral vision areas of the user reduces flicker. The aperture of the liquid crystal filter is dynamically adjusted to maintain a particular aspect ratio to match the image displayed by computers and television sets. The size of the aperture of the liquid crystal filter is user adjustable through a mechanical or electrical aperture system. The size of the aperture of the liquid crystal filter is automatically adjustable through an electrical aperture control system and a proximity system. The aperture is adjusted based on the sensed distance between the user and the display medium. The location of the aperture is automatically adjustable through an electrical aperture control system and head orientation system. The aperture location in front of the LC shutter is moved vertically or horizontally depending on the pointing direction of the users head with respect to the display system.

### BRIEF DESCRIPTION OF THE DRAWINGS

FIG. 1 illustrates regions of perceived flicker in stereoscopic shuttering systems;

FIG. 2 illustrates modified regions of perceived flicker in stereoscopic shuttering systems using variable aperture;

FIG. 3 illustrates a mechanical variable baffle for stereoscopic shutter systems;

FIG. 4 illustrates an electrical variable baffle for stereoscopic shutter systems;

FIG. 5 illustrates a stereoscopic shutter system with user adjustable variable mechanical or electrical aperture;

FIG. 6 illustrates a stereoscopic shutter system with an automatically adjustable electrical aperture; and

FIG. 7 illustrates a block diagram of an automatically adjustable aperture system for stereoscopic shutter systems.

### DETAILED DESCRIPTION OF THE INVENTION

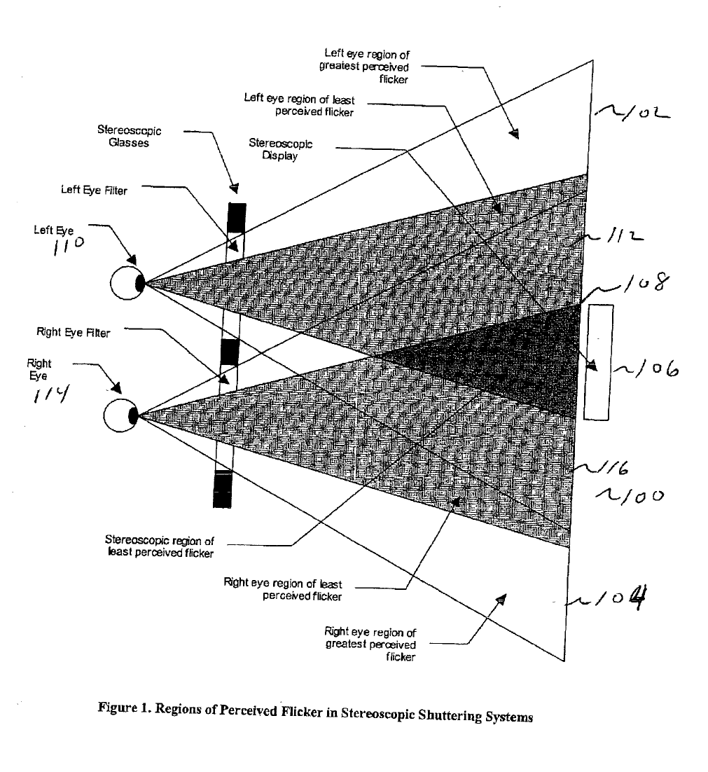

FIG. 1 illustrates a representative schematic drawing of the regions of perceived flicker and their relationships with prior art stereoscopic shutter glass systems 100. As is seen in FIG. 1, the region of greatest flicker for each is very broad and extends to the limit of the field-of view afforded by each filter clear aperture 102 and 104. Since the apparent size of the 3D or stereoscopic display system 106 is typically much smaller than the entire area visible to the eye (depending on the viewing distance), a much larger region of the field of view is perceived to flicker unnecessarily. This flicker can detract from the quality of the visual experience. If the field of view is reduced such that only the 3D or stereoscopic display is visible to the eye and further if the 3D or stereoscopic image is kept in the center of the field of view which is least sensitive to motion sensation, then the overall perceived flicker can be greatly reduced. Note the area indicated in dark gray in FIG. 1 108 is the stereoscopic region of least perceived flicker. The left eye 110 has a region of least perceived flicker perceived through the left filter 112 for that eye and the right eye has a region of least perceived flicker perceived through the right filter 114 for the right eye, 116.

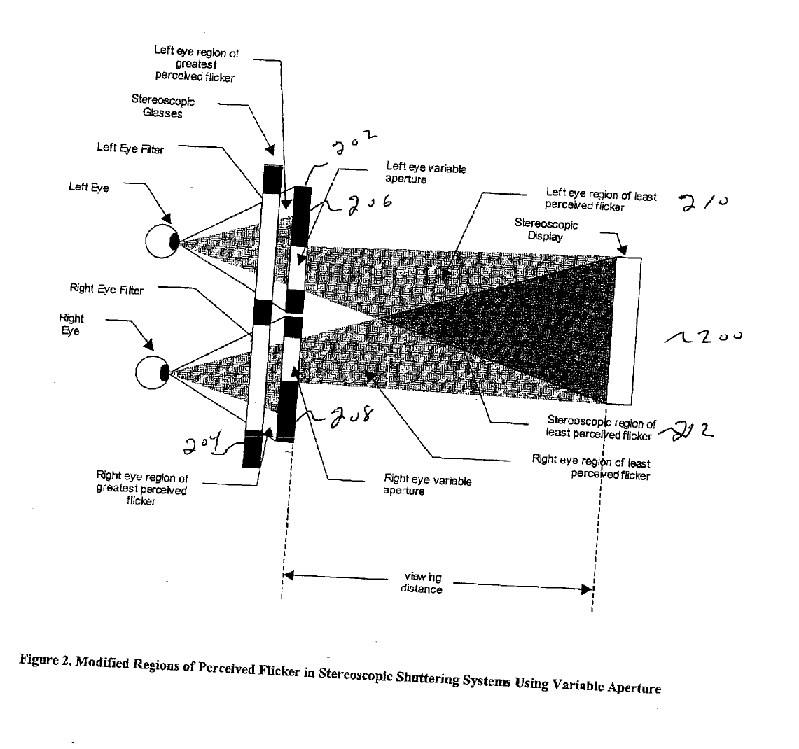

FIG. 2 illustrates a representative drawing of modified regions of perceived flicker in stereoscopic shuttering systems using a variable aperture system. 200. In FIG. 2, an aperture with a 4 by 3 aspect ratio is created using a baffle 202 placed in front of the LC shutter 204 for each eye. As can be observed, the regions of greatest flicker sensitivity are totally blocked 206 and 208 and the areas of least sensitivity 210 and 212 are centered on the 3D or stereoscopic display 214. The size of the aperture depends on the viewing distance 214 and size of the 3D or stereoscopic display.

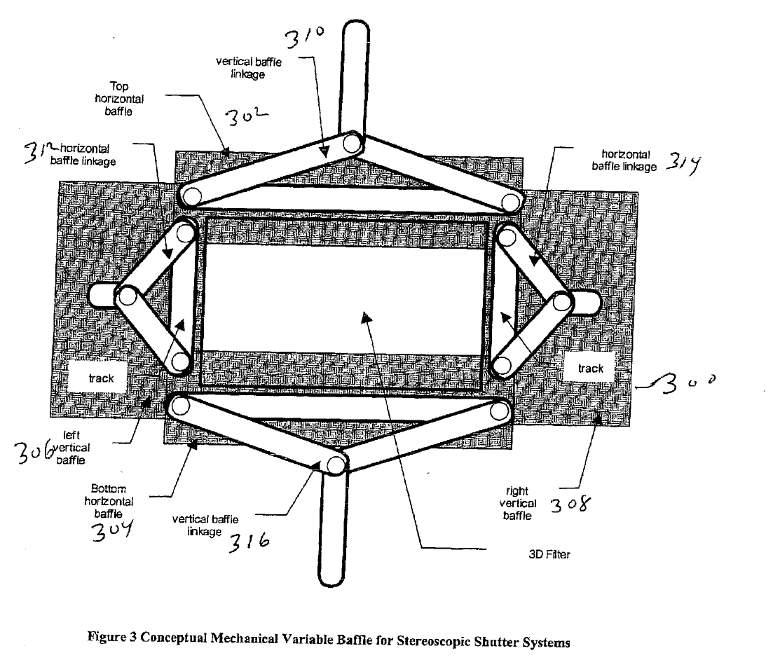

FIG. 3 illustrates a mechanical system to adjust the size of the 4 by 3 LC shutter aperture 300. A system of four baffles 302, 304, 306 and 308 is positioned in front of the LC shutter. Two sets of baffles are used to adjust the vertical and horizontal aperture widths. A system of mechanical linkages 310, 312, 314 and 316 is employed to keep the aperture centered in both the vertical and horizontal directions. Another set of linkages (not shown) is used to ensure that all four baffles move together to keep the 4:3 aspect ratio regardless of the aperture size. Finally a user adjustable lever (not shown) can be employed to make manual adjustments to the aperture. While the embodiment described above relates top a 4:3 aspect ration, other aspect rations such as 16:9 baffle systems can be for the relevant display system.

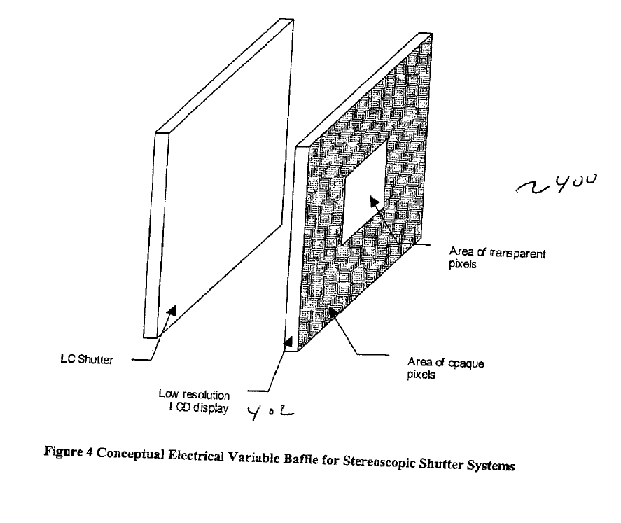

FIG. 4 Illustrates an electrical method to control the aperture size of the LC shutter 400. In this figure a low resolution LC display 402 is placed in front of the LC shutter. To create the baffle, pixels around the edges of the LC display 402 are set to block passing light (dark state) and pixels in the center of the display are set to pass light (bright state). The state of each pixel is determined by an LC controller and is arranged in a pattern that keeps the desired 4:3 aspect ratio (or other desired aspect rations as discussed above) for the aperture. In this case both the size and position of the aperture may be varied by a LC control system. The position adjustments provide an additional correction for distance and angle of view.

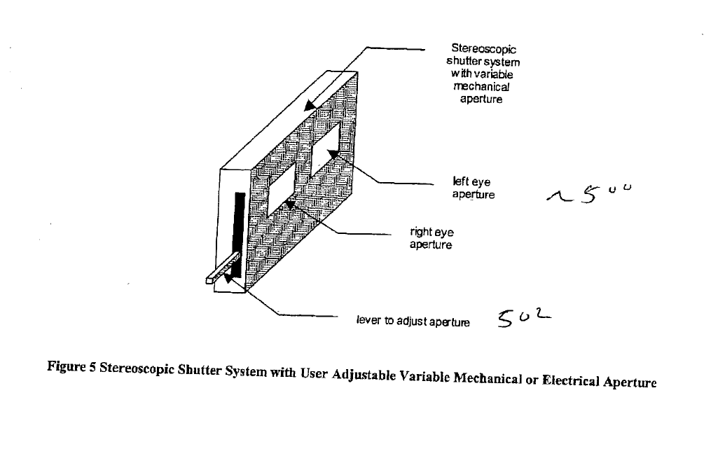

FIG. 5 illustrates a variable aperture stereoscopic shutter system 500 that is adjustable by the user through an external lever 502. This external lever may be used to control either the mechanical aperture system of or the electrical aperture system.

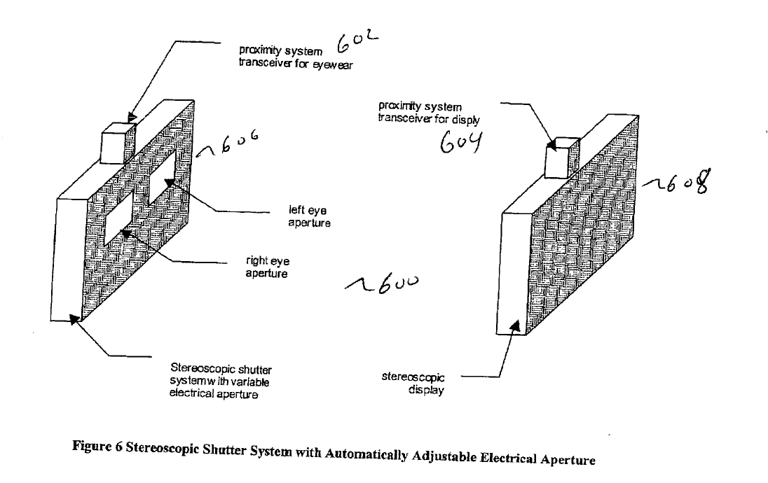

FIG. 6 illustrates an automatically adjustable aperture controls system 600. In this case proximity sensors (such as IR or ultrasonic distance sensing systems) 602 and 604 are mounted to the shutter glass system 606 and the 3D or stereoscopic display system 608. A processor inside the shutter glass system (not shown) uses these sensors to measure the viewing distance 610 and then compute and adjust the required aperture. A calibration system is provided to calibrate the system to the particular size monitor, aspect ratio and to make fine adjustments for variations among users.

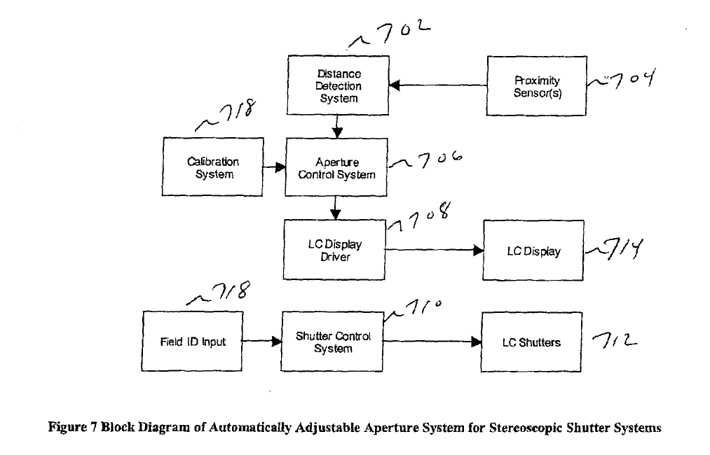

FIG. 7 illustrates a block diagram 700 of the automatically adjustable aperture system. In this figure a distance detection system 702 receives distance data from the proximity sensors 704. Distance data is fed to an aperture control system 706 that determines the size and location of the aperture based on the distance and the calibration settings. The aperture controls system sends pixel data to the LC Display Driver 708 to realize the required aperture. Independent of the aperture control system 708, the shutter control system 710 opens and closes the LC shutters 712 based on a field identification signal 718 that is synchronized to the 3D or stereoscopic display system.714. The calibration system 718 provides data about the particular display size, aspect ratio and user fine adjustments to the Aperture Control System 706

The present invention has been described with reference to the above illustrative embodiments. It us understood, however, modifications to the illustrative embodiments will readily occur to persons with ordinary skill in the art. All of such modifications and variations are deemed to be within the scope and spirit of present invention as defined by the accompanying claims.

1. A stereoscopic shutter system comprising:
a pair of LC shutters; and
a baffle system, wherein said baffle system reduces perceived flicker by limiting the field of view to include only a 3D or stereoscopic display.

2. The system of claim 1 wherein said baffle system is mounted to the outside of a pair of LC shutters to produce a smaller clear aperture thus reducing flicker.

3. The system of claim 2 wherein said baffle system is a variable system mounted to the outside of said shutters.

4. The system of claim 3 wherein said variable baffle system is a mechanical mechanism mounted to the outside of said LC shutter.

5. The system of claim 3 wherein said mechanism is set to a particular aspect ratio.

6. The system of claim 5 said aspect ratio is 4:3 where 4 represents units of the width dimension of the display and 3 represents units of the height dimension of the display.

7. The system of claim 5 said aspect ratio is 16:9 where 16 represents units of the width dimension of the display and 9 represents units of the height dimension of the display

8. The system of claim 4 wherein said mechanism is adjustable for various distances between said LC shutter and said 3D display.

9. The system of claim 3 wherein said baffle system further comprises four baffles wherein a first set of said baffles adjust a vertical aperture width and a second sets of said baffles adjust a horizontal aperture width.

10. The system of claim 9 wherein a first system of mechanical linkages keep an aperture within said baffles centered in both a vertical and horizontal direction.

11. The system of claim 10 wherein a second system of linkages ensure that said baffles move together to maintain a particular aspect ratio regardless of said aperture size.

12. The system of claim 11 said aspect ratio is 4:3 where 4 represents units of the width dimension of the display and 12 represents units of the height dimension of the display.

13. The system of claim 11 said aspect ratio is 16:9 where 16 represents units of the width dimension of the display and 9 represents units of the height dimension of the display.

14. The system of claim 11 wherein a user adjustable lever is employed to make manual adjustments of said aperture.

15. The system of claim 1 wherein a variable electro-optical baffle system is mounted to the outside of said pair of LC shutters to produce a smaller clear aperture thus reducing flicker.

16. The system of claim 1 wherein a variable electrical baffle system is mounted to the outside of said pair folk shutter to produce a smaller clear aperture thus reducing flicker due to a wide field of view and in which said variable electrical baffle system is user adjustable.

17. The system of claim 16 wherein electrical baffle system comprises a low-resolution LC display placed in front of the LC shutter.

18. The electrical baffle system of claim 17 comprises:
pixels around the edges of said LC display set to block passing light (dark state); and pixels in the center of the display are set to pass light (bright state).

19. The electrical baffle system of claim 18 further comprising:
an LC controller.

20. The electrical baffle system of claim 19, wherein said LC controller determines both the size and position of the aperture.

21. The electrical baffle system of claim 20, wherein said LC controller determines the state of each pixel and is determined by and is arranged in a pattern that maintains a particular aspect ratio aspect ratio for said aperture.

22. The system of claim 21 wherein said aspect ratio is 4:3 where 4 represents units of the width dimension of the display and 3 represents units of the height dimension of the display.

23. The system of claim 21 said aspect ratio is 16:9 where 16 represents units of the width dimension of the display and 9 represents units of the height dimension of the display.

24. The system of claim 21 wherein said baffle system is adjustable for various distances between said LC shutter pair and said 3D or stereoscopic display.

25. The system of claim 23 wherein said distance between said LC shutter pair and said 3D or stereoscopic display is determined by proximity sensors mounted to the shutter glass system and said 3D or stereoscopic display system.

26. The system of claim 24 wherein said proximity sensors comprise an IR distance sensing system.

27. The system of claim 24 wherein said proximity sensors comprise an ultrasonic distance sensing system.
